(19) United States
(12) Patent Application Publication
(10) Pub. No.: US 2001/0030231 A1
(43) Pub. Date: Oct. 18, 2001

(54) Card reading visitor data apparatus and method

(76) Inventor: Andrew C. Grossman, Minneapolis, MN (US)

Correspondence Address: STUART R. HEMPHILL, Dorsey & Whitney LLP, 220 South Sixth Street, Minneapolis, MN, 55402-1498, US

(21) Appl. No.: 09/795,874

(22) Filed: Feb. 28, 2001

Related U.S. Application Data
(60) Provisional application No. 60/186,195, filed on Mar. 1, 2000.

(51) Int. Cl. G06F 17/00

(52) U.S. Cl. 235/375

(57) ABSTRACT

A system for capturing visitor data from a visitor's visit to a show. The system comprises a visitor attractant device, a card reader associated with the visitor attractant device for reading identification data stored on a visitor card presented to the card reader, a visit context data capture program for storing context data specific to the visit of the visitor who presents the visitor card to the card reader and for associating the context data with the identification data stored on the visitor card, and a storage device for storing the context data in association with the identification data stored on the visitor card.

This Nonprovisional Application claims the benefit of U.S. Provisional Application Ser. No. 60/186,195, filed Mar. 1, 2000.

### TECHNICAL FIELD

This invention relates generally to gathering visitor data from trade shows, consumer shows, or other gatherings or the like. More particularly, the invention relates to methods and apparatuses for gathering visitor data through the use of a visitor attractant device and a card reader.

### BACKGROUND

Businesses or individuals staffing booths at trade shows, consumer shows, or tables at other gatherings frequently seek to gather information from visitors to the booths or tables for future use. Such future use could include direct mail advertising, phone calls in the future, solicitation and delivery of product orders, or any other purpose for which the information may be useful. Visitors to trade shows or other gatherings may therefore leave business or other paper identification cards with the staff of the booth. In other instances, visitors may be asked to sign in on a registration sheet or the booth staff may ask visitors their names and gather their contact information. If the booth staff wishes to obtain further information from a visitor, such as that visitor's area of interest, the booth staff may ask the visitor to fill out a questionnaire on paper or the booth staff may ask the visitor a series of questions and then transcribe the answers onto paper.

At typical consumer shows, which are advertising or commercial shows for a variety of products or services directed to the general public, neither the producer of the show nor the companies staffing tables at booths (the exhibitors) know the identities in advance of the visitors to the show. To advertise for consumer shows, mass-media advertisements, such as newspaper adds, are frequently used. Because neither the show producer nor the exhibitors know who will be attending the show, the traditional methods for gathering visitor information detailed above are commonly used.

Trade shows, which are advertising or promotional shows directed generally to business to business commerce, differ from consumer shows in that the trade show producer typically knows who will be attending the trade show as visitors. In general, therefore, the identities of the visitors are generally known to the trade show producer, and that information may be shared with the trade show exhibitors. In order for an individual trade show exhibitor to identity the visitors that visit that exhibitor's booth, however, the trade show exhibitor needs to gather information from individual visitors to the booth, and the traditional method of gathering information discussed above may be used.

Other applications have also been developed for automating the gathering of visitor information at particular booths at trade shows. One example of such a system is that used by Galaxy Information Services, LLC (see “www.expocard.com”), which issues a card known as an EXPOCARD™ to all attendees. In some of these applications, the trade show producer may generate a special visitor attendance card for each registered visitor for the show. These special visitor attendance cards have been designed with bar codes that identify the visitor and the visitor's contact information. When an individual visitor visits a particular exhibitor's booth, the visitor may present the special visitor attendance card to a card reader that reads the visitor's contact information and saves it to a storage device. The exhibitor at the booth of the trade show are therefore able to keep a list of visitors that visit that particular booth.

The methods discussed above for gathering visitor information at trade shows, consumer shows, or gatherings have a number of disadvantages. The traditional method of gathering business cards or requesting that visitors fill out a registration at each booth may be burdensome, time-consuming, and likely to result in errors. The staff of a booth may misplace business cards or registration forms. In addition, visitors may not wish to fill out registration forms or information questionnaires due to the time-consuming nature of such a registration or questionnaire. The booth exhibitor, therefore, may collect only a small portion of the identities of the visitors to the booth and little additional information.

A number of problems are also associated with the method for gathering booth visitor identities at trade shows through the use of special visitor attendance cards and card readers at individual booths. First, special visitor attendance cards are required for such methods, which can be costly to issue and inconvenient for visitors to use because the visitor must carry an extra card. Second, only the identity of the visitor and information gathered during registration is tracked using these methods (and not detailed information gathered at booths), so a booth exhibitor may only have a list of names with contact information and no other information about each visitor.

In addition to the drawbacks discussed above, each of the methods detailed above for gathering booth visitor identities fails to provide value-added services for booth exhibitors and show producers. Booth exhibitors receive only a minimal amount of information concerning a visitor—the visitor's identity and contact information. Much more detailed information about a visitor is commonly desired, such as the specific product or service the visitor is interested in, the reason the visitor initially stopped by the booth, the order and/or pattern in which the visitor visited different booths, the visitor's opinion about the exhibition booth, as well as other information about the visitor. Show producers and exhibitors could use more detailed information about visitors to consumer shows or trade shows.

A need exists for methods and systems for gathering trade or consumer show visitor information, processing that visitor information, and developing useful summaries and analyses of the visitor information.

### SUMMARY

One embodiment of the invention is a system for capturing visitor data from a visitor's visit to a show. In this embodiment, the invention comprises a visitor attractant device, a card reader associated with the visitor attractant device for reading identification data stored on a visitor card presented to the card reader, a visit context data capture program for storing context data specific to the visit of the visitor who presents the visitor card to the card reader and for associating the context data with the identification data stored on the visitor card, and a storage device for storing the context data in association with the identification data stored on the visitor card.

Another embodiment of the invention is a system for capturing visitor data from a show. In this embodiment, the invention comprises a plurality of visitor attractant devices, a card reader associated with at least one of the visitor attractant devices for reading identification data stored on a visitor card presented to the card reader, a visit context data capture device associated at least one card reader for receiving context data specific to the visit of a visitor who presents the visitor card to the card reader and for associating the context data with the identification data stored on the visitor card, and a storage device for storing the context data in association with the identification data stored on the visitor card.

Yet another embodiment of the invention is a method for capturing visitor data from a show. In this embodiment, the invention comprises providing a visitor attractant device, providing a card reader associated with the visitor attractant device for reading identification data stored on a visitor ID card presented to the card reader, developing and storing context data specific to the visit of a visitor who presents the visitor ID card to the card reader and associating the context data with the identification data stored on the visitor ID card, and responsive to a card swipe, storing in a storage device the context data in association with the identification data stored on the visitor ID card.

Another embodiment of the invention is a method for capturing visitor data from a show. In this embodiment, the invention comprises providing a plurality of visitor attractant devices, providing a card reader associated with each visitor attractant device for reading identification data stored on a visitor ID card presented to the card reader, developing visit context data specific to the visit of a visitor who presents the visitor ID card to the card reader and associating the context data with the identification data stored on the visitor ID card, and responsive to a card swipe, storing the context data in association with the data stored on the visitor ID card.

Yet another embodiment of the invention is method for capturing visitor data at a gathering place. In this embodiment, the invention comprises providing a visitor attractant device, providing a card reader associated with the visitor attractant device for reading identification data stored on a visitor ID card presented to the card reader, developing and storing context data specific to the visit of a visitor who presents the visitor ID card to the card reader and associating the context data with the identification data stored on the visitor ID card, and responsive to a card swipe, storing in a storage device the context data in association with the identification data stored on the visitor ID card.

Another embodiment of the invention is a method for assembling a customer list from visitor data collected at a gathering place. In this embodiment, the invention comprises providing a visitor attractant device, providing a card reader associated with the visitor attractant device for reading identification data stored on a visitor ID card presented to the card reader, developing and storing context data specific to the visit of a visitor who presents the visitor ID card to the card reader and associating the context data with the identification data stored on the visitor ID card, responsive to a card swipe, storing in a storage device the context data in association with the identification data stored on the visitor ID card, and determining, based on the context data, whether the visitor is likely to be a customer for a given product or service provider.

### DESCRIPTION OF THE DRAWINGS

FIG. 1 is a block diagram view of one embodiment of the system of the invention.

FIG. 2 is a diagram of a display message that may be used in one embodiment for a visitor attractant device.

FIG. 3 is a diagram of a computer screen that may be used in one embodiment for a visitor attractant device.

FIG. 4 is a block diagram of an embodiment of the invention containing a plurality of visitor attractant devices and card readers.

FIG. 5 is a diagram detailing a variety of information that may be gathered in one embodiment of the invention.

### DETAILED DESCRIPTION

The invention may be used for gathering and/or analyzing visitor information or data collected at a gathering. Such gatherings may include trade shows, shopping malls, seminars, retail stores, carnivals or festivals, or other multipurpose or multi-destination gatherings. Although the invention may be applicable to any such gathering, the embodiments of the invention described below will be described with reference to consumer shows. It is to be understood, however, that the embodiments of the invention may be applicable to other gatherings as well.

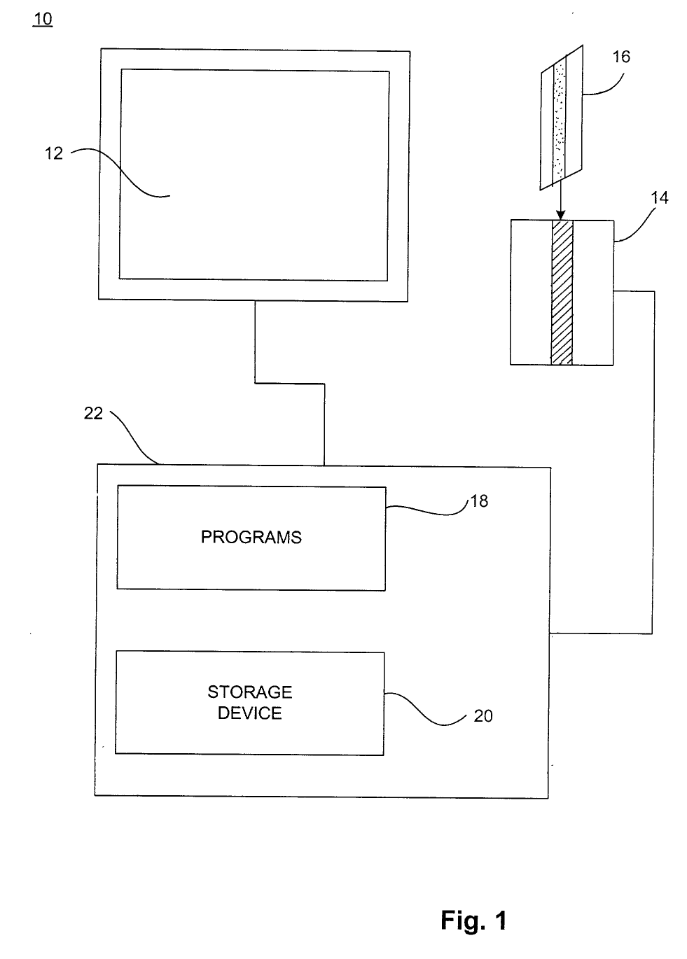

One embodiment of the invention, which is seen in FIG. 1, is a system 10 for capturing visitor data from a visitor's visit to a show. In this embodiment, the system 10 includes a visitor attractant device 12, a card reader 14 associated with the visitor attractant device 12 for reading identification data stored on a visitor card 16 presented to the card reader 14, a visit context data capture program 18 for storing context data specific to the visit of the visitor who presents the visitor card 16 to the card reader 14 and for associating the context data with the identification data stored on the visitor card 16, and a storage device 20 for storing the context data in association with the identification data stored on the visitor card 16. In general, a visitor's identification is gathered from the visitor card 16 and this information is stored in the storage device 20 along with some context data specific to the visitor's visit. The visit context data capture program 18 and storage device 20 run on a computer or computer system 22, which, as described throughout this specification, may be any type of computer or computer system known to those skilled in the art. Throughout this specification, “context data” will be used to refer to any data that is associated with a visitor's visit, including the time, date, survey information from the visitor, or any other specific information relating to the visit that may be used for analyzing the visitor's visit. The term “system proprietor” will be used in this specification to refer to a party (typically a third party that is not a booth exhibitor, show producer, or show visitor) that operates the system and method of the invention or is in control of the computer systems that maybe used to generate reports or other analyses described in more detail in the following sections.

A. General Overview and Equipment of an Embodiment of the Invention

A number of embodiments of the invention are described below. Some embodiments of the invention may be used in connection with Internet or web applications. Throughout this application, any references to computers or computer systems may include applications functioning as web applications or operating over the Internet.

1. The Visitor Attractant Device

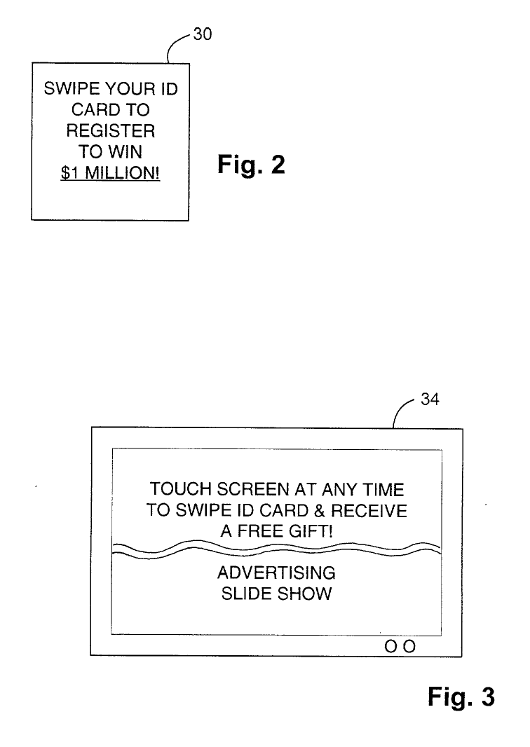

The visitor attractant device 12, as seen in FIGS. 1-3, may be any type of device that attracts the attention of visitors to the system 10 of the invention. In one embodiment, as seen in FIG. 2, the visitor attractant device 12 may simply be a display poster 30 or other type of message on cardboard or paper. In other embodiments, the visitor attractant device 12 may be a display with an image along with instructions for inviting visitor registration by swiping a visitor card 16 in the card reader 14. The visitor attractant device 12 may also be an invitation to sign up for a prize drawing or to receive a gift or a coupon for a product or service, as seen in FIGS. 2-3. In these embodiments, any type of enticement may be used to encourage a visitor to swipe a visitor card 16 through a card reader 14. In other embodiments, the visitor attractant device 12 could be a television advertisement run through a display, and any other type of video and/or audio application could also be used as the visitor attractant device 12. For example, the visitor attractant device 12 could be an Internet web page or a multimedia presentation containing many displays, many monitors that each have more than one display, or more than one monitor that each has a different display. The visitor attractant device 12, in another embodiment, may be a computer display 34 with an interactive sequence incorporating one or more invitations to swipe a visitor card 16 in the card reader 14 at different points in the sequence. For instance, in this embodiment, the visitor attractant device 12 may have a display with an interactive sequence that seeks information about the visitor or the visitor's opinion about the booth or one or more of the exhibitor's products or services. At one or more points during the interactive sequence, the visitor attractant device 12 may request a swipe of a visitor card 16 in the card reader 14 to indicate a specific interest in the context provided by a portion of the sequence.

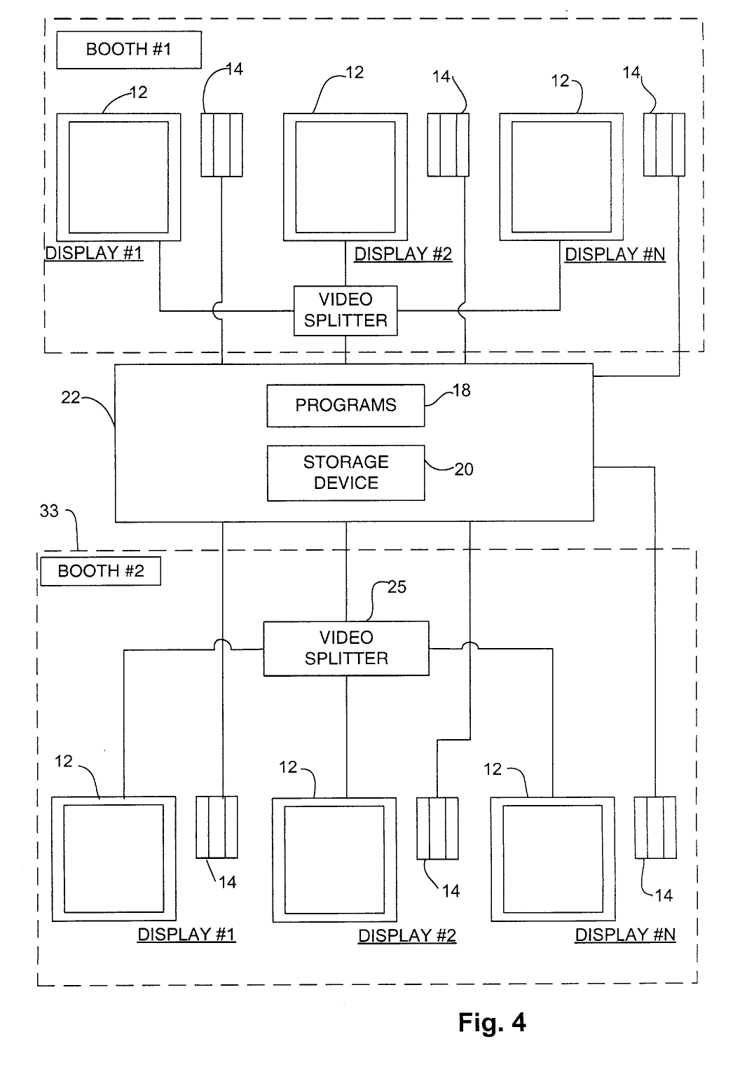

An interactive embodiment of the visitor attractant device 12 may be a slideshow running on a computer monitor, as seen in the embodiment of FIG. 3, which shows one screen of such a slideshow. In this embodiment, the slideshow may be a series of HTML pages that show features of a product or service. The same designs and techniques used to attract viewers to websites may be employed. In this embodiment, enticements to swipe a visitor card 16, as noted above, may be displayed on a portion of the computer screen. In one embodiment, the computer screen may be a touch sensitive screen or touchscreen, as known to those skilled in the art, that allows a visitor to enter certain information in response to prompts on the computer screen. The touchscreen may technically function much like a mouse as commonly used in computer applications. The buttons on the touchscreen should be sized and shaped in a manner to allow a visitor to easily answer a set of questions using the buttons. The touchscreen may be a large screen that attracts visitor attention, and the screen may contain a variety of eye-catching images. In one embodiment, there may be an indication that touching the screen at any time will launch a data-capture process through card swiping. If a visitor touches the screen at any time, therefore, the data capture screen detailed below may be launched. After successful data capture, the visitor attractant screens may be continued. In other embodiments, an interactive application could include a voice recognition system or any type of Internet application. In addition, multiple visitor attractant devices 12, as depicted in FIG. 4, could be used within a single booth at a show. These visitor attractant devices 12 could be networked together (see the video splitter 25 in FIG. 4) to present a multimedia presentation or, in other embodiments, could be stand-alone displays. In addition, as shown for booth #2 (numeral 33) in FIG. 4, an Internet feed 27 may connect one or more of the visitor attractant devices 12 or computers 22 to the Internet or Web.

2. The Card Reader

The card reader 14, as seen in FIG. 1, may be any type of device that is capable of reading data stored on a visitor card 16 that is presented to the card reader 14. In one embodiment, the card reader 14 may be a device that is capable of reading a magnetic strip on a card, as is known to those skilled in the art. In another embodiment, the card reader 14 may be an OCR device or an optically coded data reader. In sum, any type of card reader 14 known to those skilled in the art may be used for the card reader 14 of the system 10 of the invention. The visitor card 16, may be a card that is specifically made by the show producer for each visitor to a show or gathering. “Card swiping” or a “card swipe” as used throughout this specification should be read to include the use of any type of card reader known to those skilled in the art, and should not be limited to cards that are literally swiped to obtain information. In one embodiment, the visitor card 16 could be a handheld token or a device worn on a necklace that could be quickly and easily scanned by a card reader 14.

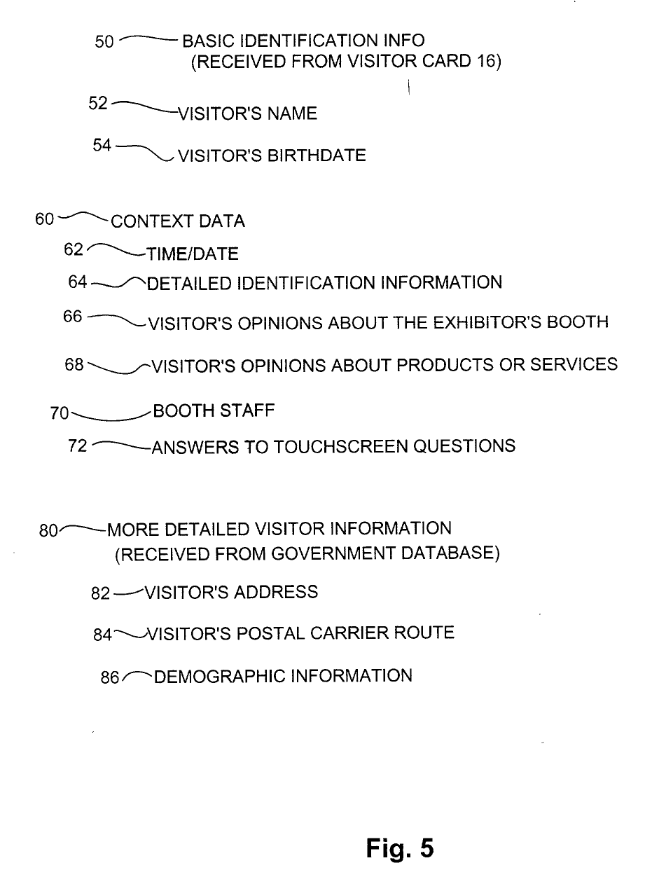

In other embodiments, the visitor card 16 may be a standard state-issued driver's license or identification card. Many states have state-issued driver's licenses or identification cards that have magnetic strips which may be read with card readers 14. Basic identification information 50 (FIG. 5) for visitors may be gathered from these visitor cards 16, such as the visitor's name 52, address 54, city 56, and driver's license number 58. After such basic identification information 50 is gathered from the visitor card 16, more detailed visitor information 80 (FIG. 5), such as the visitor's sex 87 and home zip code 82 and/or birth date 89, may be gathered from government information databases, such as license bureaus. Other detailed visitor information 80 may include the visitor's postal carrier route 84 and demographic information 86, which may help with analyzing the visitor's information for specific purposes, as detailed in the following sections of this specification. It should be noted that one advantage of using state-issued driver's licenses or identification cards as visitor cards 16 is that a special visitor card 16 need not be made for the show. In addition, it may be easier to gather additional information from license bureaus or the like if a government issued identification cards is used as the visitor card 16.

3. The Visit Context Data Capture Program

The visit context data capture program 18 and the storage device 20 may both exist within any standard computer or computer system known to those skilled in the art, such as the computer designated by numeral 22 in FIG. 1. In another embodiment, the visit context data capture program 18 and the storage device 20 may exist within separate computers or computer systems, which may be located within a booth at a show or at a remote location. Any computer or computer system and software programs known to those skilled in the art may be used within the scope of the invention. In one embodiment, a SUN computer with the Solaris operating system may be used. In another embodiment, a Compaq computer with the LINUX operating system may be used, or a Compaq computer with Windows NT, Windows 95 or Windows 98 may be used. An ORACLE database management system may be used for management of the data stored in the system 10 of the invention. It should be recognized that the above examples of computers or computer systems are exemplary only and that any other type of computer or computer system known to those skilled in the art may be used.

The visit context data capture program 18 may be any type of computer program known to those skilled in the art for storing context data specific to the visit of the visitor that presents the visitor card 16 to the card reader 14 and for associating the context data with the identification data stored on the visitor card 16. For instance, in one embodiment, the visitor's identification information may be read from the visitor card 16 and the context data may simply be the time and date that the visitor visited the particular booth in the show. FIG. 5 depicts such basic identification information as numeral 50 along with the visitor's name 52, address 54, and city 56. FIG. 5 also depicts the context data as numeral 60, and such context data 60 may include the time/date 62 (as measured by the time of a card swipe). In other embodiments, the context data 60 may be more specific, including information elicited from the visitor, such as detailed identification information 64 for the visitor, the visitor's opinions 66 about the exhibitor's booth or the visitor's opinions about one or more products or services 68. Other context data 60 may include the staff of the booth 70 when the visitor visited, or other variables relating to the activities in the booth. This information may be collected and entered for analysis by the visit context data capture program 18 by a variety of methods. In one embodiment, the staff of the booth may enter the information via keyboard and/or mouse into a computer system as the visitor speaks or answers a set of questions.

In an embodiment using a computer touchscreen as the visitor attractant device 12, the visitor attractant device 12 may be integrated into a computer system that allows for the gathering of context data. In this embodiment, the touchscreen may be used to gather such context data 60, such as answers to touchscreen questions 72 (FIG. 5) for a given visitor. After identification information has been successfully gathered from the visitor by a visitor card 16 swipe, the screen may prompt the visitor to answer any number of questions using the touchscreens. In one embodiment, the questions may be simple yes/no questions that may be simply and quickly answered by the visitor. In other embodiments, the screen (or the computer monitor) may contain a keypad that allows the visitor to enter more detailed information. In such an embodiment, a variety of context data 60 may be stored for the visitor for analysis, including which invitation to swipe led to the visitor's swipe of the visitor card 16 in the card reader 14, the path of interactions that lead to the card swipe, or visitor-entered data associated with swiping. In those systems where the visitor attractant device 12 is, in effect, a well-designed “website” leading a visitor through a variety of information and options, the visitor's transition through the “website” can lead to a stream of data much like the click stream captured when users visit a website on the Internet. This could lead to a rich collection of context data 60.

4. The Storage Device

The storage device 20 of the invention may be any type of database storage device known to those skilled in the art, including those types mentioned below. The storage device 20, as noted above, may exist in a computer or computer system, and may be located at a booth or at a central location such that information from a number of booths is stored in a central location. The storage device 20 stores the context data in association with the identification data stored on the visitor card 16 and gathered by the card reader 14.

5. Data Capture Interactive Screens

In an embodiment using a computer touchscreen as the visitor attractant device 12, a series of screens, such as that in FIG. 3, may appear in association with data capture through the card reader 14. For instance, the user may be prompted through the computer screen for card swiping. Such screens may include a main data-capture screen that invites the visitor to swipe the card with a phrase such as, “Please pass your driver's license through the card reader.” An illustration on this main page may show how to swipe the card through the card reader 14. The screen may also contain text that describes the benefits of card swiping (see FIGS. 2 and 3), such as, “Register to win $1 million by simply swiping your driver's license.” After data has been successfully captured from a visitor card 16, a page may appear thanking the visitor for swiping the visitor card 16 and indicating that the card's 16 data was successfully captured.

Numerous other screens may appear in the context of data capture in various embodiments of the invention. If the data captured from a visitor card 16 is incomplete or corrupt, a page may appear detailing the problem and prompting the visitor to swipe the card again. After a certain number of unsuccessful card swipes, the screen may direct the visitor to speak with a booth attendant. In another situation, a screen may appear if the system 10 successfully detects the card swipe but the card is the incorrect or unknown type of card that does not function with the system (i.e., if the user swipes a bank card on a system set up to read driver's licenses). In this situation, the screen may direct the user to attempt to swipe again using the proper card or to cancel the attempted card swipe. Once again, after a certain number of unsuccessful card swipes, the screen may return to the main user attractant or introduction screen. In any situation in which the visitor attempts a number of times to swipe the visitor card 16, but the swipe does not result in proper data-capture, a screen may appear that indicates that the maximum number of allowed swipes has been attempted. The screen may then apologize to the visitor, thank the visitor for stopping by the booth, and request that the visitor speak to a booth attendant.

If any screen has been displayed that requires user interaction, a timeout screen may appear after a set amount of time that explains that there has been no user interaction for the period of time. The screen may request a return to the previous screen for user interaction or a return to the main screen. After a certain period of time, the main or introduction screen will appear based on the presumption that a visitor has walked away from the screen if no response has been received within a set period of time.

In the event the visitor requests a return to the main or introduction screen from any of the screens detailed above, a confirmation screen may appear to confirm that the visitor really wants to do that. This screen may allow the visitor to return to the previous screen. Another screen may appear whenever a visitor deliberately chooses to exit from the data-capture process. Such a screen may contain a friendly message, such as “Thank you for visiting our booth.”

6. Systems Using a Plurality of Attractant Devices and Card Readers

In another embodiment of the invention, a plurality of visitor attractant devices 12 and card readers 14 may exist within a single booth at a show. Some large booths at shows contain a number of displays and/or promotions for goods or services. A visitor attractant device 12 and card reader 14 could, in one embodiment, exist at one or more of these displays at a single booth of a show. The computer or computer system storing the information could be a single system for a booth containing multiple visitor attractant devices 12 and card readers 14, or, in another embodiment, the computer system and storage device could exist at a remote central location, such that it functions to gather and store information from a number of booths at a given show. FIG. 4 depicts an embodiment of the invention in which multiple visitor attractant devices 12 (depicted as display #1, display #2, and display N) and card readers 14 are connected to a central computer system 22 for storing that information. Any number of visitor attractant devices 12 and card readers 14, denoted by display N in FIG. 4, may be included within the scope of the invention. FIG. 4 depicts that central computer system 22 as containing programs 18, which could be visitor context data programs or other software, as well as a storage device 20. It should be noted that, in one embodiment, this computer system 22 depicted in FIG. 4 could exist within the specific booth at the show, and the information from that computer system 22 could be uploaded to a central computer system for the entire show. FIG. 4 depicts that the visitor attractant devices 12 within a given booth could all be connected to a video splitter 25, which may connect the visitor attractant devices 12 to the computer system 22.

In yet another embodiment, a plurality of visitor attractant devices 12 and card readers 14 may exist at a given show, with one or more visitor attractant devices 12 and card readers 14 existing at individual booths of the show. FIG. 4 also depicts such an embodiment, wherein one set of visitor attractant devices 12 and card readers 14 exist at a first booth 31 and a second set of visitor attractant devices 12 and card readers 14 exist at a second booth 33. In such an embodiment, comparisons and other analysis may be performed based on the data collected at each booth through card swipes or other data capture processes as discussed above. Any number of booths at a show may be set up as detailed above, each with one or more visitor attractant devices 12 and card readers 14, such that detailed information from a show about particular visitors and their booth visits may be gathered and analyzed.

In embodiments using a plurality of visitor attractant devices 12 and card readers 14 in a single booth or at different booths of a show (as detailed below), the context data capture program 18 may capture information such as the location of the card swipe at a booth. For instance, the program 18 may detail which booth or which visitor attractant device 12 at a given booth attracted the card swipe. This data may be used for analyses to indicate which product or service lines or visitor attractant devices 12 from a variety of available offerings attracted a lot of attention at a given show.

7. Kiosks for Product Ordering and Retail Applications

In one embodiment, the card readers 14 and visitor attractant devices 12 at individual booths may form kiosks that contain detailed product information. For instance, a visitor to a booth could swipe a visitor card 16 through a card reader 14 at the booth and then choose from a screen that details each of the products or services sold by the booth exhibitor's company. This information could be organized in a series of linked screens and could be operated through a touchscreen system, as detailed throughout this specification. In addition to product advertising and promotion, the kiosk system could allow visitors to order specific products directly from the exhibitor's booth by simply responding to touchscreen directions for ordering a product. Because the visitor's identification information may be gathered from a visitor card 16, the ordering process may be as simple as providing screens that allow a visitor to select a product and confirm that the visitor wishes to purchase the product and have it sent to a certain location. These screens could also allow the visitor to enter credit card information or other billing information in some embodiments, or to set up an appointment for a call or meeting with a sales representative in other embodiments.

In one embodiment, computer systems at booths may provide Internet access to visitors upon swiping of visitor cards 16. In these embodiments, the visitors could access Internet pages for the exhibitor and order products or services directly from that Internet access. Basic visitor information could be collected and used from the card swipe as described above, and further swipes, such as credit card swipes, could collect information for payment for the products. In one embodiment, visitors could be given a handheld device at a booth or at the entrance to the show that could provide Internet access to the visitor. In such an embodiment, a visitor could present the handheld device to an optical reader or any other device known to those skilled in the art at a given booth, the visitor's identification information could be collected as described above, and the visitor could then be provided with Internet access via the handheld device. In other embodiments, the visitor could swipe the visitor card 16 and then access a web page for a particular booth by entering a code for that booth (which could be displayed at the booth) or by pressing a particular button on the handheld device. Information displayed to the visitor could be booth specific or general information about the show. Different images could be presented to the visitor depending on the specific area of the booth the visitor is near. For instance, in one embodiment, the handheld device could be swiped (under an optical reading device or other device known to those skilled in the art) near a first location at a booth in order to receive a web page describing a first product, and the handheld device could be swiped near a second location at a booth to receive a web page describing a second product. In one embodiment, the handheld device could have a display to function as a monitor. In other embodiments, the handheld device could use a monitor at a given booth as a display for the web page (via a wire or wireless connection). Context data 60, such as clickstream information, could be gathered for a visitor based on the web pages visited by a visitor at a given booth. In addition, the Web access could be attained using any other method known to those skilled in the art. Product orders could be requested from these web pages through simple iterations of the visitor. The visitor could also provide an e-mail address, via a keyboard, keypad, or any other method known to those skilled in the art, for future correspondence from the booth exhibitor.

In another embodiment, card readers 14 and visitor attractant devices 12, along with a computer or computer system, may be used in retail stores or malls to gather consumer (visitor) information. These systems could be placed directly at the point of sale or in other locations within the stores or malls. A variety of data could be collected, including product interest, a list of products purchased, or other information. A network of these systems at various retailers or malls in a city, state, or even a nation, could form a large database of consumer information that could be used to track purchasing patterns. The visitor data could also be used for advertising and promotional purposes. Such a system may allow retailers to more easily develop mailing lists or customers lists that may be used for promotional purposes. In addition, paper questionnaires or surveys would not need to be utilized at the point of sale, which may not interest or may frustrate many potential purchasers and may be time-consuming for store employees.

Information and data may be communicated to a central system or may be stored on local systems at each booth. In one embodiment, a communication path may be used to communicate information between booths or to a central computer system. Such a communication path may be a Local Area Network (“LAN”) of any type, a Wide Area Network (“WAN”), a private network, a public network including the Internet and the Web.

It is to be understood that other computer systems and software known to those skilled in the art may also be used. In addition, software or programs within the servers or databases of the appointment server or elsewhere may be used to carry out the functions and operations described above and below. The above feature and other features of the invention will be discussed further in the following section.

b. Operation

The systems 10 and methods of the invention may be used to gather and analyze a variety of visitor data gathered at booths of a show or at specific locations of a gathering. In one embodiment, the visitor information may be gathered at a specific booth of a show. In other embodiments, the information may be gathered at an entrance or exit for the show. In either situation, the visitor data gathered may be used for a variety of exhibitor and show producer services. In one embodiment, a system proprietor may manage the collection of visitor information so that privacy issues may be addressed. For instance, booth exhibitors may only receive the identities of those visitors who swipe visitor cards 16 at that booth exhibitor's booth. Identities of other visitors who did not visit that booth may not, in this embodiment, be provided to that specific exhibitor. Each exhibitor may receive statistical information regarding all visitors to a show who swiped cards in any card readers 14 (or to similar exhibitor booths), but specific visitor information may only be provided to those booth exhibitors that a given visitor visited and swiped a visitor card 16 through a card reader 14. Data privacy concerns, therefore, may be addressed by the system proprietor and software of the invention.

1. Gathering Visitor Data

As noted above, basic visitor identification information 50, such as the visitor's name 52 and address 54, may be gathered from a swipe of a visitor card 16 through a card reader 14. More detailed or visit specific information (context data 60) may be gathered through entry by keyboard or through the use of touchscreens, as detailed above. The types of information gathered from visitors in this manner could vary widely. In one embodiment, a survey or questionnaire (which could be a simple series of yes/no questions that would be simple for a visitor to complete), could be requested from a visitor after a visitor card 16 has been swiped through a card reader 14. These questions could ask for comparisons between products made by that exhibitor and products made by other exhibitors. The questions could also seek information about the visitor's opinions about the exhibitor's booth or opinions about the exhibitor's competitor's booths. With such information, comparisons could be conducted across product lines or within certain product lines to allow the booth exhibitor to ascertain the effectiveness of its booth, its product lines, and/or its advertising.

The information detailed above could also be requested at an entrance or, more likely, an exit of the show. The system proprietor could, therefore, set up a card reader 14 and visitor attractant device 12 at the exit of the show, and then (in a similar manner as outlined above) request a wide variety of information from show visitors. General questions could be asked about which booths were most effective, which were least effective, what the visitor liked about the show as a whole, and what the visitor did not like about the show as a whole. A wide variety of market or product research associated with particular identified persons could be conducted by the show producer in this manner, and this information could be analyzed and sold to booth exhibitors.

2. Exhibitor Services

The programs and software of the invention may be used to analyze the data collected from visitors and to provide a number of reports and services to the booth exhibitors at a show. Here the advantage of card swipe data and computer display touchscreen collection techniques becomes evident. These collection techniques mean there is no little or no need for manual data entry with its costs and potential errors. These services may include, in one embodiment, general visitor attendance analysis, post-show visitor data analysis, and pre-show visitor data analysis. The post-show visitor data analysis may include sorting the visitor data by various criteria and then sending reports to booth exhibitors. Reports may include shared reports, which may be reports sent to all booth exhibitors at a given show that provide information and comparative analysis of exhibitor booth activity for each booth. The information could be reported in a number of different ways, such as for each data element sorted by booth and based on the captured visitor and context data 60. In another embodiment, a cooperative report could include a report to booth exhibitors in a specific product category (such as windows) that indicates each visitor that visited any “window” booth or related booth at the show. Another type of report could include an individual report, which could be tailored for a specific booth exhibitor. Such an individual report could break up and analyze visitor data collected from a show for each visitor that visited that exhibitor's booth. In another embodiment, an individual report could include a list of all visitors who visited booths in the given exhibitor's product category. Post-show reports could be used to correlate visitor purchasing interest in any statistical methodology for given booth exhibitors or to correlate visitor information for different geographical areas.

Pre-show mailers may also be developed and sent using the system and methods of the invention, and these mailers could be developed using any of the above reports or other information. Such mailers could be developed to be sent to show visitors. These mailers, as above, could be cooperative mailers (on behalf of a number of booth exhibitors or the show producer) or individual mailers (on behalf of one exhibitor). Pre-show mailers could be developed using information from a specific show. For instance, all visitors that visited a booth in a given product category at one show could be invited to a later show for that given product category. In another embodiment, a specific booth exhibitor could request that all visitors from previous shows who expressed an interest (as measured in booth visits) in the same or related product categories be invited to the show.

General attendance analysis could include a variety of types of analyses based on the visitor data gathered at a given show. A specific booth exhibitor may wish to know the total number of visitors who visited its booth, which could be expressed as a specific number of visitors, the specific number of visitors out of the total number of visitors to the show, and the number of visitors to the booth as a percent of the total number of visitors to the show. The booth exhibitors could also be grouped in specific product categories and the booth exhibitors within a given product category could be ranked by the number of visitors to the booth. In other embodiments, booth exhibitors may want to correlate the interest in their booth to the interest in other booths in the same or related product areas, based on traffic at a show. The systems and methods of the invention may be used to determine related product areas for visitors based on correlated visitor information. For instance, the system and method of the invention may be used to perform an analysis that determines that visitors who visit a window manufacturer booth will also visit a booth for a paint supplier. Some of these product area correlations may be intuitive, while others may not be intuitive and may be determined based solely on statistical information gathered from visitor visits to booths. Lists could be composed for an exhibitor from such information that could show visitors who did not visit the exhibitor's booth, but who may be likely to be interested in the exhibitor's products based on visits to other booths in the same or related product category. The booth exhibitors would therefore be able to ascertain the effectiveness of the booth at the show, and booth exhibitors could learn that other exhibitors in the same product category were more effective at attracting visitors at the show. Simple information such as the time and date (or other context data 60) of visitor visits to a given booth may also help the booth exhibitors in determining the appropriate staffing for a booth at given times during the day or days during the week.

Show exhibitors may also wish to receive detailed, sorted information about visitors to the show, such as those visitors within a certain distance of the booth exhibitor's store location(s) or those visitors located in a certain zip code or within a certain distance of a given location. Visitors could also be sorted by post office carrier routes or parts of town. Such sorting of visitors may allow certain booth exhibitors to more appropriately target advertising. Specific demographic information may lead to the generation of lists. For instance, census data may be available that details demographic information for given postal carrier routes. Such demographic information may be received from a variety of sources and could detail demographic statistics by zip code, city, or general location. Some booth exhibitors may desire a list of visitors sorted by demographic information in order to assist with targeted advertising. Individual booth exhibitors may also want customized lists for high-end or low-end business (as determined by visitor home location—high or low income areas).

Cooperative mailers for some or all of the booth exhibitors could be used to provide an economic advantage for the participating booth exhibitors. An advertisement (either before a certain show or after a given show) could be mailed or sent via e-mail to show visitors who expressed an interest in certain product lines, as measured by card swipes at certain booths. Pools of booth exhibitors, such as a pool for all exhibitors in the window business, could be set up to allow for economical advertising. For instance, a joint mailer could be sent on behalf of all such exhibitors instead of requiring each exhibitor to send its own mailing. Certain correlations of data captured in accordance with the invention may also be developed across each product category. For instance, based on an analysis of information from a given show, it may be determined that those visitors who visited window booths also visited remodeler booths. Statistical analysis may also be used to determine the percent of visitors who did not visit an exhibitor's booth while visiting other booths in similar product categories. The order in which visitors visited booths may also be important and may be analyzed. If a visitor visited a booth on windows before a booth on remodeling, it may be assumed that the visitor is more interested in windows than in remodeling. Conversely, if a booth on remodeling is visited before a booth on windows by a visitor, it may be determined that the visitor learned something from the remodeling booth that prompted the visitor to visit the windows booth. There may, therefore, be a learning process of visitors that could be ascertained using the visitor information gathered by the system and method of the invention. Visitors may be grouped according to the type of customer they are likely to be based on the order (or priority) in which they visit booths at a show. Such data may be helpful in determining which products or services visitors may be likely to purchase. A variety of lists could be developed that correlate purchasing interest based on statistical likelihoods that certain types of visitors would be interested in certain types of product or services lines. Such correlations could also be carried out by the order that certain visitors visited booths. For instance, it may be determined that visitors who visited the booths in a certain order are more likely to express product interests in a certain product area. A variety of known data mining techniques can be applied to data captured in accordance with the invention.

3. Producer Services

In addition to the services and analyses offered for booth exhibitors, a number of types of analysis of visitor information and services may be offered for show producers. Producer analyses and services may include attendance at shows by day and by hours as measured by visitor attendance at exhibitor booths or as measured by card readers 14 positioned at the entrance or exit to the show. As noted above, a system 10 could be placed at the exit to the show to collect a variety of information from show visitors. Such data collection systems may be useful for consumer shows where show producers do not know who will show up prior to the show. A show producer may be given access to all of the visitor information gathered at a given show, which may allow the show producer to target advertising for future shows. For instance, the show producers may determine that most show visitors are from suburban locations, and hence advertising can be targeted to such locations (i.e., metro newspapers or local radio advertisements), which may save the show producer money on advertising.

In addition, the card readers 14 may be used to gather information from booth exhibitors, such as an exhibitor's satisfaction with the booth location at the show, the location of the show, or other details of the show for which the producer is responsible. Show producers may also cooperate with exhibitors with targeted mailings for shows, such that the show producer can advertise for the show in the same advertisement (mailing) used for an advertisement by a show exhibitor.

The traffic at a show may be monitored by a show producer using the system and method of the invention. It may be determined that certain locations on a show floor receive the highest amount of traffic due to the floor layout. It may also be determined that the position of one booth relative to another increases traffic to a booth. For instance, proximity to a booth for a company with cutting-edge technology or strong public brand awareness may lead to higher traffic than positioning far away from that booth. Based on data gained through the system and method of the invention, analysis can be performed to allow show producers to more efficiently price booths at a show. For instance, higher traffic booth locations may result in higher fees charged by show producers. Similar information could be provided to booth exhibitors so that the exhibitors could conduct a cost-benefit analysis to select a desirable booth location at a show.

4. Internet or Web Applications

Some embodiments of the invention may use the Web for providing information to show producers or booth exhibitors. In these embodiments, show producers or booth exhibitors could request certain information in a number of different categories or sorted by a given category, and the data could be analyzed and provided to the individual user (the show producer or booth exhibitor). For instance, a system proprietor could operate a website for the visitor information system. A booth exhibitor could then log on to the website and request a list of all visitors who visited that exhibitor's booth during a previous show and who live in a certain area (as measured by zip code or city name). After the information is sorted and analyzed at the server level, a list outputting the information could be provided to the exhibitor. Similar features could be used for a variety of applications as described above. Such an embodiment would be simple and convenient for show producers and exhibitors to use, as information could be requested and received on demand by producers and exhibitors.

Other Web embodiments could include gathering consumer or visitor information (based on visitor visits to booths) that could be used to form a ready pool of customers for websites. In such an embodiment, visitor's interests could be correlated based on visits to booths during shows, and this information could be used for e-mail invitations to visit websites of companies in correlated product areas. Such an embodiment would provide a low-cost method of aggregating marketing information for website operators or booth exhibitors with websites. For instance, money could be saved on broad, mass media advertisements because targeted advertising (via e-mail or otherwise) could be developed using visitor information gathered from shows. Rather than advertising to the public at large (which could be costly), therefore, targeted advertising could be achieved based on interests expressed by visitors via booth visits at shows. In some embodiments, visitor e-mail addresses could be gathered at individual booths through interactive programs (or otherwise, such as keypad or keyboard access) or at an entrance or exit to a show.

In other embodiments, visitor attractant devices 12 at booths could provide visitors with web access upon a card swipe by the visitor. For instance, access to a booth exhibitor's web page, the show producer's web page, or a third party's web page (such as the system proprietor) could be provided upon a card swipe or, in other embodiments, specific product pages from such a website could be provided to the visitor. In other embodiments, product pages may not be web pages, but may be generated by stand alone computers at the booth level. In still other embodiments, a web page for the show itself could be provided by the show producer or by a third party to the visitor via the Internet (or direct dial connection). In any of these embodiments, web pages for the show or exhibitor could be accessed by individual visitors at locations other than the show itself (such as home computers), and basic identification information collected from the show could exist within the system to help make any registration needed for product ordering easier for a visitor.

C. Conclusion

The method and system of the invention provide numerous advantages over the prior art. First, context data associated with a visitor's visit to a booth, which may be as basic as a time or date stamp, but may also capture other associated context information developed from visitor attractant devices 12, may be collected and stored along with visitor identification information received from the visitor card 16. This data collection allows for a variety of analyses to be performed that may be useful to a booth exhibitor or a show producer, as detailed above. Second, detailed visitor information, such as demographic information, may be collected from government or private databases in embodiments using a state-issued driver's license or identification card as the visitor card. This detailed visitor information may be useful to show producers or booth exhibitors in a variety of formats after it has been analyzed. Third, context data collected through touchscreens, keypads, or other means located near visitor attractant devices and card readers aid in analyzing visitor information received at shows. Using such context data, which may be received in a manner that does not inconvenience a visitor, allows for the production of a variety of services that may be beneficial to booth exhibitors, show producers, and visitors to the show. Fourth, the chances of receiving visitor information at booths or at an entrance or exit to a show are increased through the use of visitor attractant devices, which may, in one embodiment, provide benefits to a visitor who swipes a visitor card at a given booth (or entrance or exit to the show). Fifth, with automated data capture, errors are reduced and the data is higher quality. Several other benefits and advantages of the invention will be apparent to those skilled in the art.

The accompanying Figures described above depict embodiments of the present invention, and features and components thereof. With regard to references in this specification to computers, the computers may be any standard computer including standard attachments and components thereof (e.g., a disk drive, hard drive, CD player or network server that communicates with a CPU and main memory, a sound board, a keyboard and mouse, and a monitor). The processor of the CPU in the computer may be any conventional general purpose single- or multi-chip microprocessor such as a Pentium® processor, a Pentium® Pro processor, a 8051 processor, a MIPS® processor, a Motorola Processor, a Power PC® processor, or an ALPHA® processor. In addition, the processor may be any conventional special purpose processor such as a digital signal processor or a graphics processor. The microprocessor has conventional address lines, conventional data lines, and one or more conventional control lines. With regard to references to software, the software may be standard software used by those skilled in the art or may be coded in any standard programming language to accomplish the tasks detailed below.

The system and method of the invention may use the “World Wide Web” (“Web” or “WWW”), which is that collection of servers on the Internet that utilize the Hypertext Transfer Protocol (“HTTP”). HTTP is a known application protocol that provides users access to resources, which may be information in different formats such as text, graphics, images, sound, video, Hypertext Markup Language (“HTML”), as well as programs. Upon specification of a link by the user, the client computer makes a TCP/IP request to a Web server and receives information, which may be another “Web page” that is formatted according to HTML. Users can also access other pages on the same or other servers by following instructions on the screen, entering certain data, or clicking on selected icons.

Servers or other computer systems may run on a variety of platforms, including UNIX machines, although other platforms, such as Windows 95, Windows NT, and Macintosh may also be used. Computer users can view information available on servers or networks on the Web through the use of browsing software, such as Netscape Navigator, Microsoft Internet Explorer, Mosaic, or Lynx browsers. A typical Web page is an HTML document with text, “links” that a user may activate (e.g. “click on”), as well as embedded URL's pointing to resources, such as images, video or sound, that the client may activate to fully use the Web page in a browser. Furthermore, HTTP allows for the transmission of certain information from the client computer to a server. The server can then post this information on its website, forward it on to another user or server, or save it to a database for later use.

While the present invention has been described with reference to several embodiments thereof, those skilled in the art will recognize various changes that may be made without departing from the spirit and scope of the claimed invention. Accordingly, this invention is not limited to what is shown in the drawings and described in the specification but only as indicated in the appended claims, nor is the claimed invention limited in applicability to one type of computer or computer network. Any numbering or ordering of elements in the following claims is merely for convenience and is not intended to suggest that the ordering of the elements of the claims has any particular significance other than that otherwise expressed by the language of the claims.

What is claimed is:

1. A system for capturing visitor data from a visitor's visit to a show, comprising:
(a) a visitor attractant device;
(b) a card reader associated with the visitor attractant device for reading identification data stored on a visitor card presented to the card reader;
(c) a visit context data capture program for storing context data specific to the visit of the visitor who presents the visitor card to the card reader and for associating the context data with the identification data stored on the visitor card; and
(d) a storage device for storing the context data in association with the identification data stored on the visitor card.

2. The system of claim 1 wherein the attractant device is associated with an exit.

3. The system of claim 1 further comprising an input device associated with the attractant device for accepting user input in response to the attractant device.

4. The system of claim 3 wherein the input device is a touch sensitive computer screen.

5. The system of claim 1 wherein the visitor attractant device comprises a display for a promotional giveaway in exchange for registration.

6. The system of claim 1 wherein the visitor attractant device comprises a display soliciting product interest for one or more products.

7. The system of claim 1 wherein the visitor attractant device comprises an advertisement display.

8. A system for capturing visitor data from a show, comprising:
(a) a plurality of visitor attractant devices;
(b) a card reader associated with at least one of the visitor attractant devices for reading identification data stored on a visitor card presented to the card reader;
(c) a visit context data capture device associated at least one card reader for receiving context data specific to the visit of a visitor who presents the visitor card to the card reader and for associating the context data with the identification data stored on the visitor card; and
(d) a storage device for storing the context data in association with the identification data stored on the visitor card.

9. The system of claim 8 wherein at least one attractant device is associated with an exit.

10. The system of claim 8 further comprising an input device associated with each attractant device for accepting user input in response to each attractant device.

11. The system of claim 10 wherein each input device is a touch sensitive computer screen.

12. The system of claim 8 further comprising means for analyzing the visitor data collected at the show.

13. A method for capturing visitor data from a show, comprising:
(a) providing a visitor attractant device;
(b) providing a card reader associated with the visitor attractant device for reading identification data stored on a visitor ID card presented to the card reader;
(c) developing and storing context data specific to the visit of a visitor who presents the visitor ID card to the card reader and associating the context data with the identification data stored on the visitor ID card; and
(d) responsive to a card swipe, storing in a storage device the context data in association with the identification data stored on the visitor ID card.

14. The method of claim 13 wherein the act of providing a visitor attractant device comprises providing a visitor attractant device associated with an exit.

15. The method of claim 13 further comprising providing an input device associated with the visitor attractant device for accepting user input in response to the visitor attractant device and for storing the user input with the context and identification data stored responsive to a card swipe.

16. A method for capturing visitor data from a show, comprising:
(b) providing a plurality of visitor attractant devices;
(b) providing a card reader associated with each visitor attractant device for reading identification data stored on a visitor ID card presented to the card reader;
(c) developing visit context data specific to the visit of a visitor who presents the visitor ID card to the card reader and associating the context data with the identification data stored on the visitor ID card; and
(d) responsive to a card swipe, storing the context data in association with the data stored on the visitor ID card.

17. The method of claim 16 wherein the act of providing a plurality of visitor attractant devices comprises providing at least one visitor attractant device associated with an exit.

18. The method of claim 16 further comprising providing an input device associated with each visitor attractant device for accepting user input in response to the visitor attractant device and for storing the user input with the context and identification data stored responsive to a card swipe.

19. The method of claim 16 further comprising analyzing the visitor data collected at one show by the path of an individual.

20. The method of claim 16 further comprising analyzing the visitor data collected at one show by comparison within a single booth.

21. The method of claim 16 further comprising analyzing the visitor data collected at one show by comparison between multiple booths.

22. The method of claim 16 further comprising analyzing the visitor data collected at one show by booth location.

23. The method of claim 16 further comprising analyzing the visitor data collected at one show by booth staffing.

24. The method of claim 16 further comprising analyzing the visitor data collected at multiple shows by comparison of the same booth at each show.

25. A method for capturing visitor data at a gathering place, comprising:
(a) providing a visitor attractant device;
(b) providing a card reader associated with the visitor attractant device for reading identification data stored on a visitor ID card presented to the card reader;
(c) developing and storing context data specific to the visit of a visitor who presents the visitor ID card to the card reader and associating the context data with the identification data stored on the visitor ID card; and
(d) responsive to a card swipe, storing in a storage device the context data in association with the identification data stored on the visitor ID card.

26. A method for assembling a customer list from visitor data collected at a gathering place, comprising:
(a) providing a visitor attractant device;
(b) providing a card reader associated with the visitor attractant device for reading identification data stored on a visitor ID card presented to the card reader;
(c) developing and storing context data specific to the visit of a visitor who presents the visitor ID card to the card reader and associating the context data with the identification data stored on the visitor ID card;
(d) responsive to a card swipe, storing in a storage device the context data in association with the identification data stored on the visitor ID card; and
(e) determining, based on the context data, whether the visitor is likely to be a customer for a given product or service provider.

27. The method of claim 26, wherein act (e) further comprises using clickstream data received from the visitor's visit to a website provided at the gathering place and associated with the visitor attractant device.
